(19) United States
(12) Patent Application Publication
(10) Pub. No.: US 2011/0115613 A1
(43) Pub. Date: May 19, 2011

(54) WIRELESS IC TAG, CONCRETE STRUCTURAL OBJECT QUALITY MANAGEMENT SYSTEM USING SAME

(76) Inventors: Kikuo Kaga, Tokyo (JP); Shigeo Ashizawa, Tokyo (JP)

(21) Appl. No.: 13/001,702

(22) PCT Filed: Oct. 6, 2009
(86) PCT No.: PCT/JP2009/067684

§ 371 Date: Dec. 28, 2010

(30) Foreign Application Priority Data
Jun. 18, 2009 (JP) 2009-145829
Aug. 13, 2009 (JP) 2009-187642

(51) Int. Cl. G06K 7/01

(52) U.S. Cl. 340/10.51

(57) ABSTRACT

A wireless IC tag 1 attached to or embedded in a concrete structural object 11 including a ferroelectric memory using a ferroelectric having a power source unit for receiving a radio wave from outside and for generating an electric current by resonating with the radio wave and an antenna unit for carrying out wireless communication in a predetermined frequency bandwidth, a temperature sensor 4, a Ph sensor 5, and a distortion sensor 6 which are mounted on a substrate 2. At least any one of temperature data of the structural object measured by the temperature sensor 4, hydrogen-ion exponent data of the structural object measured by the Ph sensor 5, and distortion data of the structural object measured by the distortion sensor 6 is saved in the ferroelectric memory.

### TECHNICAL FIELD

The present invention relates to a wireless IC tag and a quality management system of a concrete structural object using the wireless IC tag and especially to a wireless IC tag which can save large amount of data having a sensing function of various values regarding a concrete structural object and a system using the wireless IC tag.

### BACKGROUND ART

In recent years, a non-volatile memory unit using an FeRAM which utilizes a ferroelectric as a memory device for an IC tag has been invented. The non-volatile memory unit includes a power source unit which receives a radio wave from outside and generates an electric current by resonance with the wave, an antenna unit for carrying out wireless communication, and a control unit for controlling these units (Patent Document 1).

The non-volatile memory unit described in the Patent Document 1 has advantages in various fields such as number of times for rewriting, lower writing voltage, unnecessity of a power source, longer life time of usage, and smaller cell size compared to an EEPROM conventionally used for an IC tag. At present, one IC tag has approximately 8 Kbyte of memory capacity and the tag itself functions as a memory unit while the tag also functions as a CPU, which is a computing device.

A passive-type wireless IC tag by the electromagnetic induction method, which is also called an RFID tag, causes a magnetic field, which is generated around a coil antenna by radio wave applied to the antenna, to be a transmission medium to carry out communication with outside by an electromotive force induced by the antenna.

On the other hand, in a concrete structural object including concrete or mortar in which cement, an aggregate, and water are mixed, temperature, hydrogen-ion exponent, and existence of a distortion becomes a very important index for retention of safety of the structural object.

That is, for prevention of a damage by handling of a product after concrete is demolded or for confirmation that the cement product has a desired strength during casting, and further for suppression of temperature cracking, a concrete structural object requires temperature control. Therefore, it is required that the temperature of the concrete structural object is subject to observation of time dependent change.

Moreover, a cement product configuring a concrete structural object is strong alkaline with Ph 12 to 13 and due to this strong alkaline property, a precise oxide layer having a thickness of approximately 3 nm which is called a passivation film (γ-Fe203.nH20) is formed on the surface of a reinforcing steel in the reinforced concrete to protect the steel from oxidation. However, if neutralization of this strong alkaline concrete proceeds and hydrogen-ion exponent in the periphery of the reinforcing steel becomes Ph 11.5 or lower, the passivation film is destroyed and the reinforcing steel begins to be corroded. Therefore, it is required to observe time dependent change of the hydrogen-ion exponent in a concrete structural object.

In addition, it is required for a concrete structural object to avoid a possibility of collapsing due to the deterioration of the concrete structural object caused by the above-mentioned reason, or deformation of the structural object caused by an external reason such as earthquake. Therefore, it is required to observe time dependent change of distortion which is generated in the concrete structural object.

Systems for managing quality of a concrete structural object have been conventionally invented. An embedding type RFID module including a temperature sensor in a cast concrete (Patent Document 2), a seismic sensor provided inside a wall of a building (Patent Document 3) and the like have been invented. However, these structural object management systems mount only a sensor for measuring a specific value.

However, to build a safer concrete structural object when concrete is cast and to increase safety of the concrete structural object by finding early a danger of collapse or the like of the structural object due to quake resistance or deterioration of the object for quality management, it is required to comprehensively observe the concrete structural object from a plurality of factors such as the temperature of the concrete structural object, hydrogen-ion exponent, and distortion, and there is a demand that measurement of such data be easily and securely carried out without taking a concrete sample from the concrete structural object.
Patent Document 1: Japanese Unexamined Patent Application Publication No. 2007-241576
Patent Document 2: Japanese Unexamined Patent Application Publication No. 2006-71575
Patent Document 3: Japanese Unexamined Patent Application Publication No. 2007-16486

### DISCLOSURE OF INVENTION

### Problem to be Solved by the Invention

To solve the above-mentioned problem, a wireless IC tag of the present invention is a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and a temperature sensor electrically connected with the ferroelectric memory, wherein temperature data of the structural object measured by the temperature sensor is saved in the ferroelectric memory.

Moreover, a wireless IC tag of the present invention is a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and a Ph sensor electrically connected with the ferroelectric memory, wherein hydrogen-ion exponent data of the structural object measured by the Ph sensor is saved in the ferroelectric memory.

In addition, a wireless IC tag of the present invention is a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and a distortion sensor electrically connected with the ferroelectric memory, wherein distortion data of the structural object measured by the distortion sensor is saved in the ferroelectric memory.

A wireless IC tag of the present invention is a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and at least two of temperature sensor, a Ph sensor, and a distortion sensor electrically connected with the ferroelectric memory, wherein at least any one of temperature data of the structural object measured by the temperature sensor, hydrogen-ion exponent data of the structural object measured by the Ph sensor, and distortion data of the structural object measured by the distortion sensor is saved in the ferroelectric memory.

Further, the wireless IC tag includes a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth which are electrically connected to be mounted on a substrate so that communication in a frequency band longer than the UHF band is carried out by the antenna unit of the ferroelectric memory and the data is saved in the ferroelectric memory, and at the same time communication in the UHF band is carried out by the UHF band communication antenna chip and the data is saved in the ferroelectric memory.

Further, the wireless IC tag includes a substrate covered with an insulating material which mounts a ferroelectric memory using a ferroelectric having a power source unit for receiving a radio wave from outside and for generating an electric current by resonating with the radio wave and an antenna unit for carrying out wireless communication in a predetermined frequency bandwidth.

Further, the temperature sensor is any one of a resistance temperature detector, a thermocouple, and a thermistor and an electric signal detected by the temperature sensor is saved in the ferroelectric memory.

Further, a Ph sensor is a semi-conductor imaging sensor in which a film provided to the sensor is brought into contact with a measurement portion of the concrete structural object so that the sensor detects reactivity at the measurement portion, amount of acid/alkaline attached to the portion, amount of acid/alkaline released from inside of the measurement portion, or the like, or a glass electrode sensor having a glass electrode and a comparison electrode for detecting potential difference between the electrodes and an electric signal detected by the Ph sensor is saved in the ferroelectric memory.

Further, the distortion sensor is a displacement sensor for detecting the amount of change in relative positions of at least two points of the concrete structural object and an electric signal detected by the distortion sensor is saved in the ferroelectric memory.

Further, the sensor that the wireless IC tag includes is mounted on the substrate.

The wireless IC tag is electrically connected with a battery which is recharged by a recharging device in a contactless manner.

The battery is recharged in a contactless manner by a radio wave in a predetermined frequency band from the recharging device.

The battery is mounted on the substrate.

The recharging device for recharging the battery is provided to a writing/reading apparatus.

Power to drive the sensor that the wireless IC tag includes is supplied from a battery which is recharged from a recharging device in a contactless manner.

The wireless IC tag is electrically connected with a power generation mechanism for carrying out power generation by itself by vibration, heat, or radio wave.

The power generation mechanism is mounted on the substrate.

Power to drive the sensor that the wireless IC tag includes is supplied from a power generation mechanism which generates power by itself by vibration, heat, or radio wave.

A concrete structural object quality management system using the wireless IC tag of the present invention is a wireless IC tag attached to or embedded in a concrete structural object which can carry out writing and reading of data between a writing/reading apparatus by wireless communication, having a ferroelectric memory using a ferroelectric having a power source unit for receiving a radio wave from outside and for generating an electric current by resonating with the radio wave and an antenna unit for carrying out wireless communication in a predetermined frequency bandwidth, and a temperature sensor electrically connected with the ferroelectric memory, wherein a control unit mounted on the ferroelectric memory has a means for controlling the temperature sensor, a means for the temperature sensor to measure temperature of the concrete structural object, and a means for saving temperature data of the structural object thus measured in the ferroelectric memory.

Moreover, a concrete structural object quality management system using the wireless IC tag of the present invention is a wireless IC tag attached to or embedded in a concrete structural object which can carry out writing and reading of data between a writing/reading apparatus by wireless communication, having a ferroelectric memory using a ferroelectric having a power source unit for receiving a radio wave from outside and for generating an electric current by resonating with the radio wave and an antenna unit for carrying out wireless communication in a predetermined frequency bandwidth, and a Ph sensor electrically connected with the ferroelectric memory, wherein a control unit mounted on the ferroelectric memory has a means for controlling the Ph sensor, a means for the Ph sensor to measure hydrogen-ion exponent of the concrete structural object, and a means for saving hydrogen-ion exponent data of the structural object thus measured in the ferroelectric memory. [0031] Further, a concrete structural object quality management system using the wireless IC tag of the present invention is a wireless IC tag attached to or embedded in a concrete structural object which can carry out writing and reading of data between a writing/reading apparatus by wireless communication, having a ferroelectric memory using a ferroelectric having a power source unit for receiving a radio wave from outside and for generating an electric current by resonating with the radio wave and an antenna unit for carrying out wireless communication in a predetermined frequency bandwidth, and a distortion sensor electrically connected with the ferroelectric memory, wherein a control unit mounted on the ferroelectric memory has a means for controlling the distortion sensor, a means for the distortion sensor to measure distortion of the concrete structural object, and a means for saving distortion data of the structural object thus measured in the ferroelectric memory.

Further, a concrete structural object quality management system using the wireless IC tag of the present invention is a wireless IC tag attached to a concrete structural object or embedded in a concrete structural object when concrete is cast which can carry out writing and reading of data between a writing/reading apparatus by wireless communication, having a ferroelectric memory using a ferroelectric having an a power source unit for receiving a radio wave from outside and for generating an electric current by resonating with the radio wave and antenna unit for carrying out wireless communication in a predetermined frequency bandwidth, and at least two or more of a temperature sensor, a Ph sensor, and a distortion sensor electrically connected with the ferroelectric memory, wherein a control unit mounted on the ferroelectric memory has a means for controlling each sensor, a means for each sensor to measure data of the concrete structural object, and a means for saving the data of the concrete structural object thus measured in the ferroelectric memory.

Further, a concrete structural object quality management system using the wireless IC tag of the present invention is a wireless IC tag attached to or embedded in a concrete structural object which can carry out writing and reading of data between a writing/reading apparatus by wireless communication, having a ferroelectric memory using a ferroelectric having a power source unit for receiving a radio wave from outside and for generating an electric current by resonating with the radio wave and an antenna unit for carrying out wireless communication in a predetermined frequency bandwidth, and at least any one of a temperature sensor, a Ph sensor, and a distortion sensor electrically connected with the ferroelectric memory, and having a means for saving, if any of the sensors detects an amount of change, the detected data in the ferroelectric memory.

The wireless IC tag is electrically connected with a battery which is recharged by a recharging device in a contactless manner and power for driving the sensor that the wireless IC tag includes is supplied from the battery.

The wireless IC tag is electrically connected with a power generation mechanism which generates power by itself by vibration, heat, or radio wave and power for driving the sensor that the wireless IC tag includes is supplied from the power generation mechanism.

### Effect of the Invention

According to the above-mentioned configuration, since the wireless IC tag having a temperature sensor attached to or embedded in a concrete structural object which can carry out writing and reading of data between a writing/reading apparatus by wireless communication including a ferroelectric memory using a ferroelectric having a power source unit for receiving a radio wave from outside and for generating an electric current by resonating with the radio wave and an antenna unit for carrying out wireless communication in a predetermined frequency bandwidth, and a temperature sensor electrically connected with the ferroelectric memory, wherein temperature data of the structural object measured by the temperature sensor is saved in the ferroelectric memory so that wireless data communication can be carried out, is used, it is easy to measure temperature inside the concrete and to extract temperature data. At the same time, since the temperature data which has been measured with a certain interval can be saved in the large-volume memory of the wireless IC tag, it becomes possible for a person in charge of the construction site or a person who manages after casting to easily and quickly carry out estimation of strength of the concrete by use of temperature and accumulated temperature for each of actually used concrete and therefore the present invention contributes to improvement of safety of a concrete structural object.

Moreover, since the wireless IC tag having a Ph sensor attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and the Ph sensor electrically connected with the ferroelectric memory, wherein hydrogen-ion exponent data of the structural object measured by the Ph sensor is saved in the ferroelectric memory so that wireless data communication can be carried out, is used, it is easy to measure hydrogen-ion exponent inside the concrete and to extract the hydrogen-ion exponent data. At the same time, since the hydrogen-ion exponent data thus measured with a certain interval can be saved in the large-volume memory of the wireless IC tag and hydrogen-ion exponent of the concrete can be measured by each of the actually used concrete, it becomes possible for a person in charge of the construction site or a person who manages after casting to easily and quickly carry out estimation of neutralization of the concrete by use of the hydrogen-ion exponent data of the concrete and therefore the present invention contributes to improvement of safety of a concrete structural object.

Further, since the wireless IC tag having a distortion sensor attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and a distortion sensor electrically connected with the ferroelectric memory, wherein distortion data of the structural object measured by the distortion sensor is saved in the ferroelectric memory so that wireless data communication can be carried out, is used, it is easy to measure distortion of the concrete structural object and to extract the distortion data. At the same time, since the distortion data thus measured with a certain interval can be saved in the large-volume memory of the wireless IC tag and distortion of the concrete can be measured by each of the actually used concrete, it becomes possible for a person in charge of the construction site or a person who manages after casting to easily and quickly find out deterioration of the concrete structural object, crack in the concrete structural object due to an external factor such as earthquake, or the like by use of the distortion data and therefore the present invention contributes to improvement of safety of a concrete structural object.

Further, since the wireless IC tag having a compound sensor attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and at least two of temperature sensor, a Ph sensor, and a distortion sensor electrically connected with the ferroelectric memory, wherein at least any one of temperature data of the structural object measured by the temperature sensor, hydrogen-ion exponent data of the structural object measured by the Ph sensor, and distortion data of the structural object measured by the distortion sensor is saved in the ferroelectric memory so that the temperature, hydrogen-ion exponent, and distortion of the structural object can be measured and saved by one medium can be provided, it becomes possible to carry out comprehensive measurement of the concrete structural object by one wireless IC tag as well as the above-mentioned effects, and a person in charge of the construction site or a person who manages after casting can obtain a plurality of data by use of one writing/reading apparatus. Therefore, it becomes possible to carry out quality management of a concrete structural object easily and quickly.

Further, since the wireless IC tag includes a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth, which are electrically connected to be mounted on a substrate so that communication in a frequency band longer than the UHF band is carried out by the antenna unit of the ferroelectric memory and the data is caused to be saved in the ferroelectric memory, and at the same time communication in the UHF band is carried out by the UHF band communication antenna chip and the data is saved in the ferroelectric memory, communication in the UHF band having a wide communication range other than a frequency band such as LF band used by a conventional wireless IC tag can be carried out. Therefore, it becomes possible to easily and quickly carry out reading and writing of data by use of a writing/reading apparatus in a large-scale concrete structural object.

Further, since the wireless IC tag includes a substrate covered with an insulating material which mounts a ferroelectric memory using a ferroelectric having a power source unit for receiving a radio wave from outside and for generating an electric current by resonating with the radio wave and an antenna unit for carrying out wireless communication in a predetermined frequency bandwidth, even if the wireless IC tag is embedded in a concrete structural object, the wireless IC tag is not damaged and the wireless IC tag can be used for a long period of time.

Further, since the temperature sensor is any one of a resistance temperature detector, a thermocouple, and a thermistor and an electric signal detected by the temperature sensor is saved in the ferroelectric memory, it becomes possible to carry out accurate measurement of temperature, to configure a small temperature sensor which can be connected with the wireless IC tag or mounted on the same substrate as that of the wireless IC tag, and to provide a relatively small wireless IC tag for sensing.

Further, since the Ph sensor is a semi-conductor imaging sensor in which a film provided to the sensor is brought into contact with a measurement portion of the concrete structural object so that the sensor detects reactivity at the measurement portion, amount of acid/alkaline attached to the portion, amount of acid/alkaline released from inside of the measurement portion, or the like, or a glass electrode sensor having a glass electrode and a comparison electrode for detecting potential difference between the electrodes and an electric signal detected by the Ph sensor is saved in the ferroelectric memory, it becomes possible to accurately measure the hydrogen-ion exponent, to configure a small Ph sensor which can be connected with the wireless IC tag or provided to the same substrate as that of the wireless IC tag, and to provide a relatively small wireless IC tag for sensing.

Further, since the distortion sensor is a displacement sensor for detecting the amount of change in relative positions of at least two points of the concrete structural object and an electric signal detected by the distortion sensor is saved in the ferroelectric memory, it becomes possible to accurately measure distortion of a concrete structural object, to configure a small distortion sensor which can be connected with the wireless IC tag or provided to the same substrate as that of the wireless IC tag, and to provide a relatively small sensor device.

Further, since the sensor that the wireless IC tag includes is mounted on the substrate, it becomes possible to carry out quality management of a concrete structural object by one small and thin sensor device.

Further, since the wireless IC tag is electrically connected with a battery which is recharged by a recharging device in a contactless manner, even if the wireless IC tag is embedded in a concrete structural object or mixed in a cement product such as ready-mixed concrete where electricity cannot be supplied by a cable, it becomes possible to recharge from outside in a wireless manner. Therefore, it becomes possible to provide a wirelessly rechargeable wireless IC tag.

Since the battery is recharged by the recharging device in a contactless manner by a radio wave having a predetermined frequency band, it becomes possible to recharge the battery by a radio wave from a wireless communication apparatus or other transmission apparatus and therefore there is not a possibility of heating or the like compared to recharging by use of, for example, electromagnetic induction and it becomes possible to safely carry out recharging in a contactless manner.

Since the battery is mounted on the substrate, it becomes possible to provide a small wireless IC tag having a small sensor which is modularized and can be recharged.

Since the recharging device for recharging the battery is provided to the writing/reading apparatus, it becomes possible to recharge the wireless IC tag by use of an opportunity for writing or reading of data to or from the wireless IC tag.

Since power of the sensor that the wireless IC tag includes is supplied from a battery, which is recharged from a recharging device in a contactless manner, to drive the sensor, it becomes possible to easily supply power to the temperature sensor, the Ph sensor, and the distortion sensor positioned in the concrete structural object and to drive these sensors without connecting with an external power source.

Since the wireless IC tag is electrically connected with a power generation mechanism which generates power by itself by vibration, heat, or radio wave, even if the wireless IC tag is embedded in a concrete structural object or mixed in a cement product such as ready-mixed concrete where electricity cannot be supplied by a cable, it becomes possible for the wireless IC tag to generate power by itself by a factor such as vibration, heat, or radio wave and to accumulate power thus generated depending on the necessity. Therefore, it becomes possible to provide a wireless IC tag which can generate power by itself.

Since the power generation mechanism is mounted on the substrate, it becomes possible to provide a small modularized wireless IC tag having a sensor which can generate power.

Since the sensor which the wireless IC tag includes is driven by power supplied from the power generation mechanism which generates power by itself by vibration, heat, or radio wave, it becomes possible to easily supply power to the temperature sensor, the Ph sensor, and the distortion sensor positioned in the concrete structural object and to drive these sensors without connecting with an external power source.

Since the wireless IC tag having a temperature sensor attached to or embedded in a concrete structural object which can carry out writing and reading of data between a writing/reading apparatus by wireless communication has a ferroelectric memory using a ferroelectric having a power source unit for receiving a radio wave from outside and for generating an electric current by resonating with the radio wave and an antenna unit for carrying out wireless communication in a predetermined frequency bandwidth, and a temperature sensor electrically connected with the ferroelectric memory, wherein a control unit mounted on the ferroelectric memory has a means for controlling the temperature sensor, a means for the temperature sensor to measure temperature of the concrete structural object, and a means for saving temperature data of the structural object thus measured in the ferroelectric memory, measurement of temperature inside the concrete and extraction of temperature data can be easily carried out and at the same time temperature data measured with a certain interval can be saved in the large-volume memory of the wireless IC tag. Therefore, it becomes possible for a person in charge of the construction site or a person in charge of management after casting to carry out estimation of strength of concrete by use of temperature and accumulated temperature easily and quickly and it also becomes possible to provide a management system of a concrete structural object which contributes to improvement of safety of a concrete structural object.

Moreover, since the wireless IC tag having a Ph sensor attached to or embedded in a concrete structural object which can carry out writing and reading of data between a writing/reading apparatus by wireless communication has a ferroelectric memory using a ferroelectric having a power source unit for receiving a radio wave from outside and for generating an electric current by resonating with the radio wave and an antenna unit for carrying out wireless communication in a predetermined frequency bandwidth, and the Ph sensor electrically connected with the ferroelectric memory, wherein a control unit mounted on the ferroelectric memory has a means for controlling the Ph sensor, a means for the Ph sensor to measure hydrogen-ion exponent of the concrete structural object, and a means for saving hydrogen-ion exponent data of the structural object thus measured in the ferroelectric memory, measurement of hydrogen-ion exponent inside the concrete and extraction of hydrogen-ion exponent data can be easily carried out. Since the hydrogen-ion exponent data thus measured with a certain interval can be saved in the large-volume memory of the wireless IC tag and hydrogen-ion exponent of the concrete can be measured by each of the actually used concrete, it becomes possible for a person in charge of the construction site or a person who manages after casting to easily and quickly carry out estimation of neutralization of the concrete by use of the hydrogen-ion exponent. Therefore, it becomes possible to provide a concrete structural object management system which can contribute to improvement of safety of a concrete structural object.

Further, since the wireless IC tag having a distortion sensor attached to or embedded in a concrete structural object which can carry out writing and reading of data between a writing/reading apparatus by wireless communication has a ferroelectric memory using a ferroelectric having a power source unit for receiving a radio wave from outside and for generating an electric current by resonating with the radio wave and an antenna unit for carrying out wireless communication in a predetermined frequency bandwidth, and a distortion sensor electrically connected with the ferroelectric memory, wherein a control unit mounted on the ferroelectric memory has a means for controlling the distortion sensor, a means for the distortion sensor to measure distortion of the concrete structural object, and a means for saving distortion data of the structural object thus measured in the ferroelectric memory, it is easy to measure distortion of the concrete structural object and to extract the distortion data. At the same time, since the distortion data thus measured with a certain interval can be saved in the large-volume memory of the wireless IC tag and distortion of the concrete can be measured by each of the actually used concrete, it becomes possible for a person in charge of the construction site or a person who manages after casting to easily and quickly find out deterioration of the concrete, crack in the concrete structural object due to an external factor such as earthquake, or the like by use of the distortion data of the concrete. Therefore it becomes possible to provide a concrete structural object management system which can contribute to improvement of safety of a concrete structural object.

Further, since the wireless IC tag attached to or embedded in a concrete structural object which can carry out writing and reading of data between a writing/reading apparatus by wireless communication has a ferroelectric memory using a ferroelectric having a power source unit for receiving a radio wave from outside and for generating an electric current by resonating with the radio wave and an antenna unit for carrying out wireless communication in a predetermined frequency bandwidth, and at least two or more of a temperature sensor, a Ph sensor, and a distortion sensor electrically connected with the ferroelectric memory, wherein a control unit mounted on the ferroelectric memory has a means for controlling each sensor, a means for each sensor to measure data of the concrete structural object, and a means to save the data of the concrete structural object thus measured in the ferroelectric memory, it becomes possible to measure and save some factors such as temperature of the concrete structural object, hydrogen-ion exponent, and distortion by one medium. Therefore, in addition to the above-mentioned effects, measurement of a concrete structural object can be carried out comprehensively and a person in charge of the construction site or a person in charge of management after casting can obtain a plurality of data by one writing/reading apparatus. Therefore, it becomes possible to provide a concrete structural object management system which can carry out quality management of a concrete structural object comprehensively, easily, and quickly.

Further, since the wireless IC tag attached to or embedded in a concrete structural object which can carry out writing and reading of data between a writing/reading apparatus by wireless communication has a ferroelectric memory using a ferroelectric having a power source unit for receiving a radio wave from outside and for generating an electric current by resonating with the radio wave and an antenna unit for carrying out wireless communication in a predetermined frequency bandwidth, and at least any one of a temperature sensor, a Ph sensor, and a distortion sensor electrically connected with the ferroelectric memory, and has a means for saving, if any of the sensors detects an amount of change, the detected data in the ferroelectric memory, sensing is carried out always or with a relatively short interval, data can be saved if there is any change in data, and saved data volume to memory capacity can be reduced. Therefore it becomes possible to provide a concrete structural object quality management system which can be operated for a long period of time.

Since the wireless IC tag is electrically connected with a battery which is recharged by a recharging device in a contactless manner and power for driving the sensor that the wireless IC tag includes is supplied from the battery, power can be supplied to each of the sensors without relying on an external power source using a cable.

Since the wireless IC tag is electrically connected with a power generation mechanism which generates power by itself by vibration, heat, or radio wave and power for driving the sensor that the wireless IC tag includes is supplied from the power generation mechanism, power can be supplied to each of the sensors without relying on an external power source using a cable.

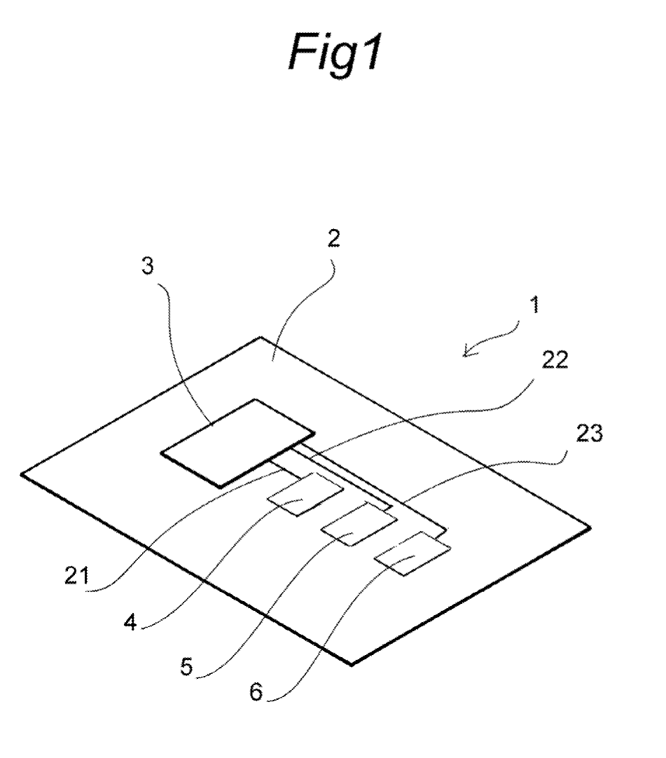

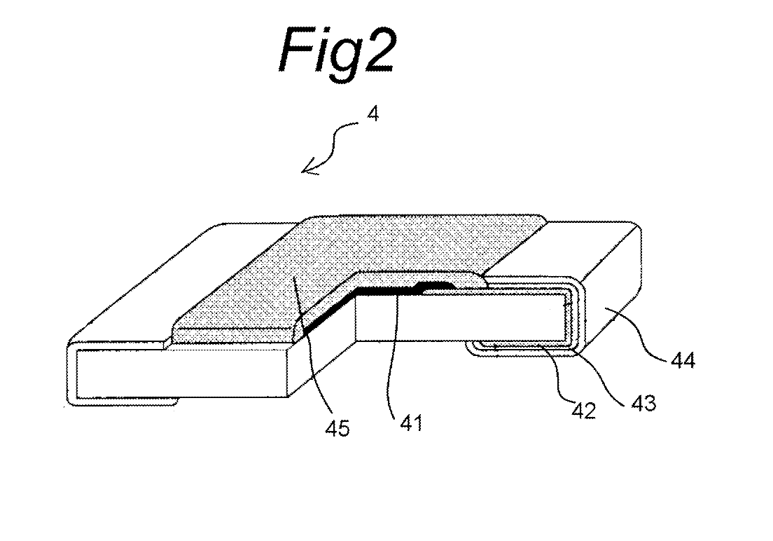

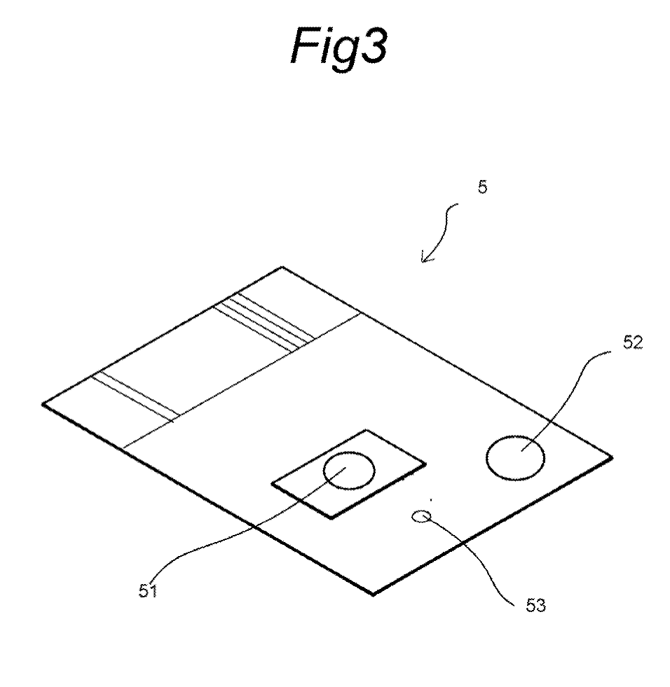

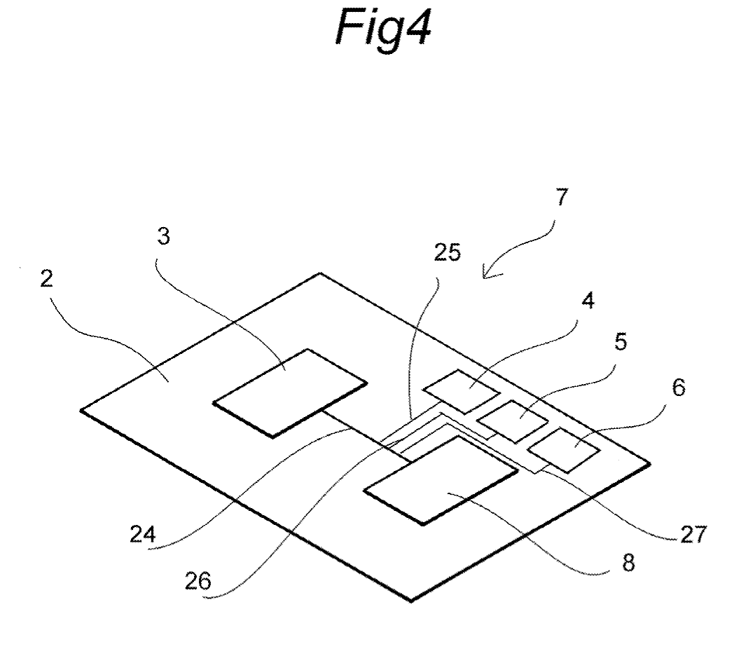

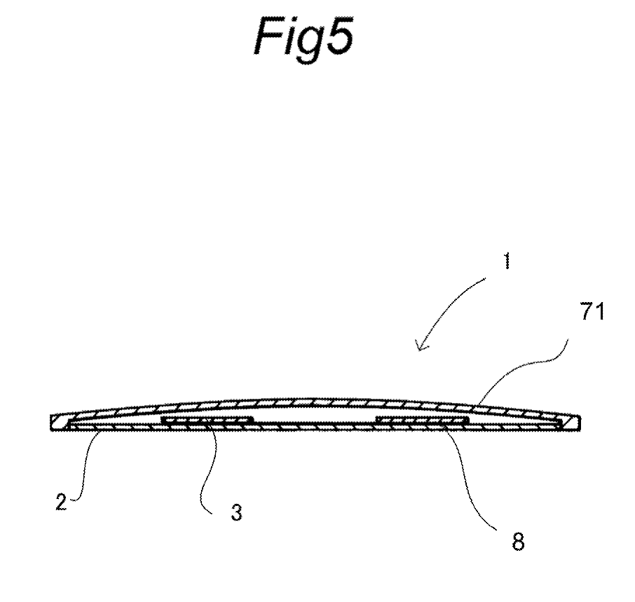

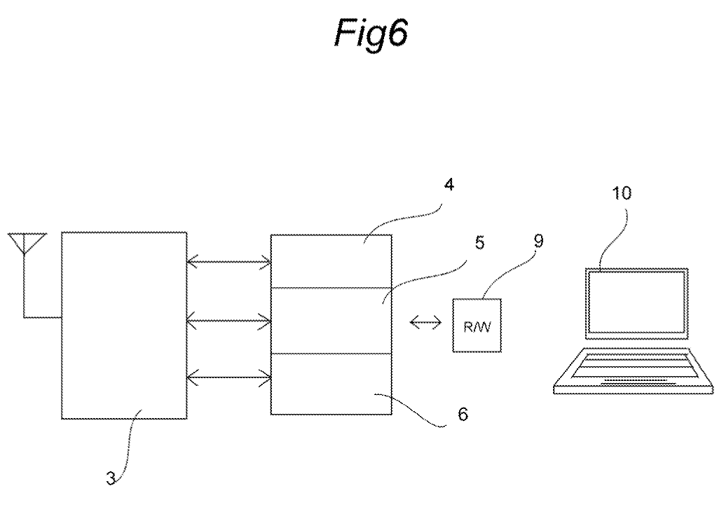

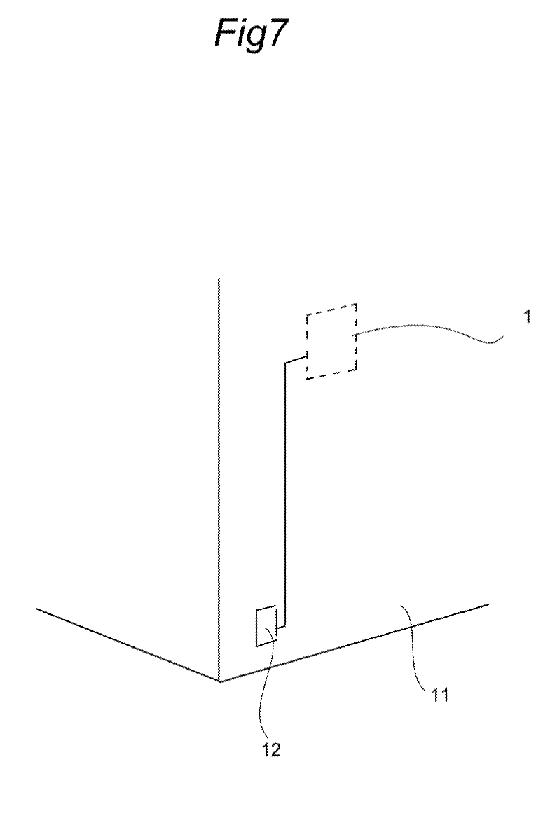

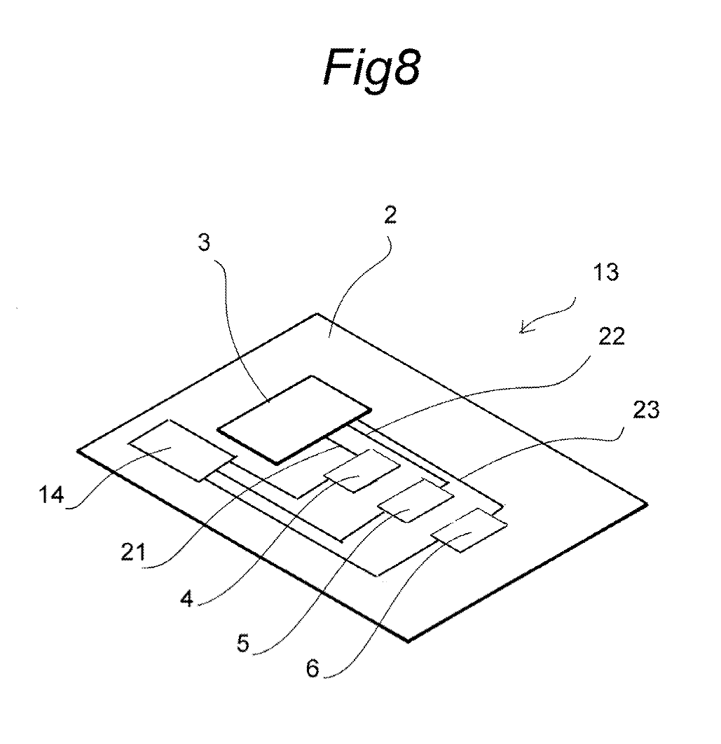

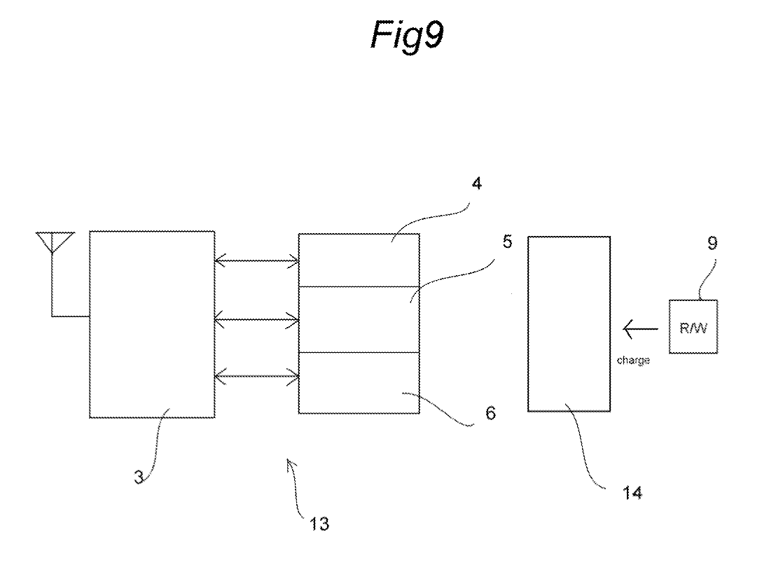

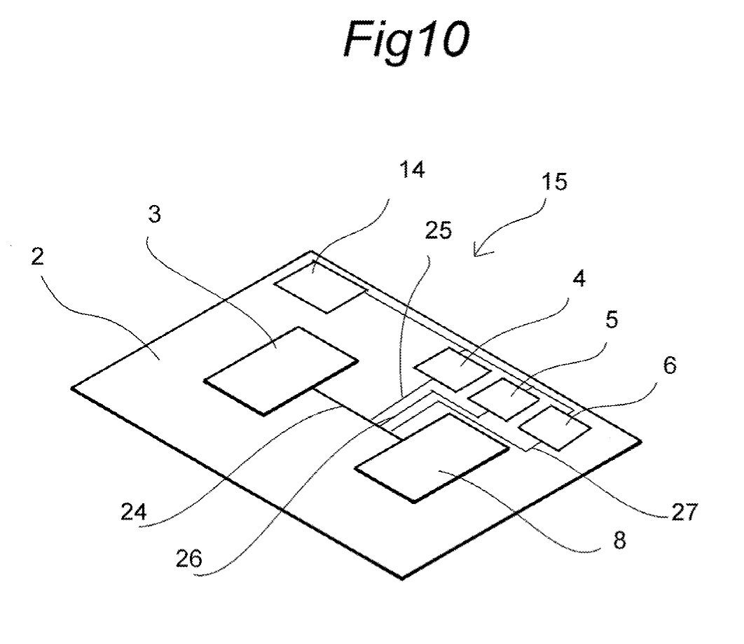

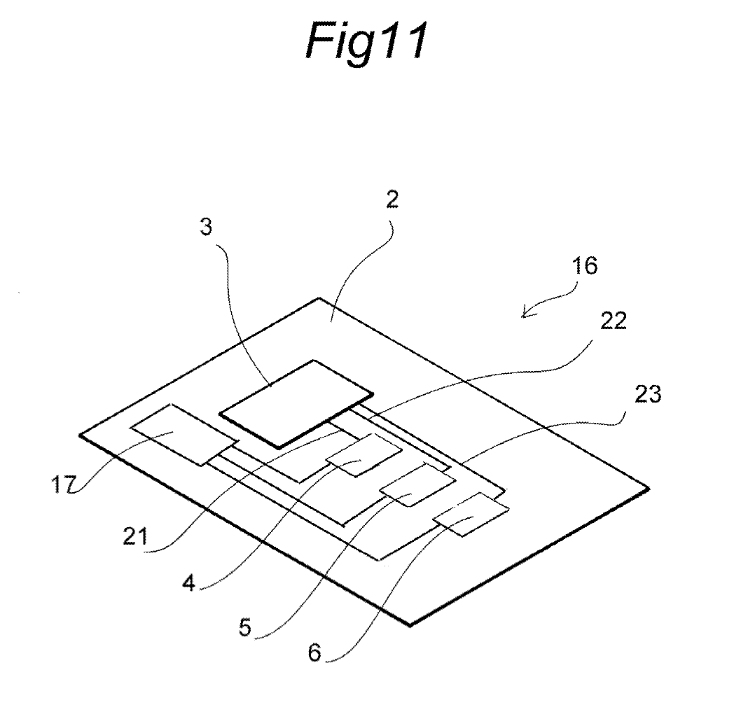

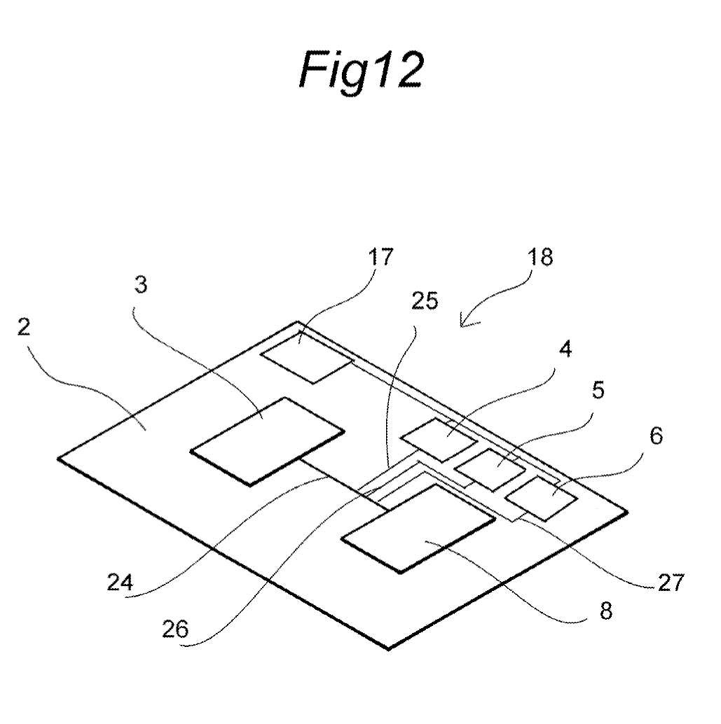

### BRIEF DESCRIPTION OF THE DRAWINGS

[FIG. 1] A schematic perspective view of a wireless IC tag of a first embodiment of the present invention.

[FIG. 2] A schematic perspective view of a temperature sensor used for the wireless IC tag shown in FIG. 1.

[FIG. 3] A schematic perspective view of a Ph sensor used for the wireless IC tag shown in FIG. 1.

[FIG. 4] A schematic perspective view of a wireless IC tag of a second embodiment of the present invention.

[FIG. 5] A cross-sectional view of the wireless IC tag shown in FIG. 4 which is covered with an insulating material.

[FIG. 6] A schematic view showing an example of a management system using the wireless IC tag of the present invention.

[FIG. 7] A perspective view showing a condition where the wireless IC tag of the present invention is embedded in a concrete structural object.

[FIG. 8] A schematic perspective view of a wireless IC tag of a third embodiment of the present invention.

[FIG. 9] A schematic view showing an example of a management system using the wireless IC tag shown in FIG. 8.

[FIG. 10] A schematic perspective view of a wireless IC tag of a fourth embodiment of the present invention.

[FIG. 11] A schematic perspective view of a wireless IC tag of a fifth embodiment of the present invention.

[FIG. 12] A schematic perspective view of a wireless IC tag of a sixth embodiment of the present invention.

### DESCRIPTION OF REFERENCE NUMERALS

1: Wireless IC tag;
2: Substrate;
21: Wire;
22: Wire;
23: Wire;
24: Wire;
25: Wire;
26: Wire;
3: FeRAM chip;
4: Temperature sensor;
41: Thermistor;
42: Internal electrode;
43: Plate layer;
44: Plate layer;
45: Protection film;
5: Ph sensor;
51: Glass electrode;
52: Comparison electrode;
53: liquid junction;
6: Distortion sensor;
7: Wireless IC tag;
71: Insulation material;
8: UHF band communication antenna chip;
9: Reader/writer
10: Computer;
11: Concrete structural object;
12: External power source;
13: Wireless IC tag;
14: Battery;
15: Wireless IC tag;
16: Wireless IC tag;
17: Power generation mechanism; and
18: Wireless IC tag

### BEST MODE FOR CARRYING OUT THE INVENTION

FIG. 1 is a schematic perspective view of a wireless IC tag of a first embodiment of the present invention, FIG. 2 is a schematic perspective view of a temperature sensor used for the wireless IC tag shown in FIG. 1, and FIG. 3 is a schematic perspective view of a Ph sensor used for the wireless IC tag shown in FIG. 1. FIG. 4 is a schematic perspective view of a wireless IC tag of a second embodiment of the present invention, FIG. 5 is a cross-sectional view of the wireless IC tag shown in FIG. 4 which is covered with an insulating material, FIG. 6 is a schematic view showing an example of a management system using the wireless IC tag of the present invention, and FIG. 7 is a perspective view showing a condition where the wireless IC tag of the present invention is embedded in a concrete structural object. FIG. 8 is a schematic perspective view of a wireless IC tag of a third embodiment of the present invention, FIG. 9 is a schematic view showing an example of a management system where the wireless IC shown in FIG. 8 is used, FIG. 10 is a schematic perspective view of a wireless IC tag of a fourth embodiment of the present invention, FIG. 11 is a schematic perspective view showing a fifth embodiment of the present invention, and FIG. 12 is a schematic perspective view showing a sixth embodiment of the present invention.

A wireless IC tag 1 of the present invention showing a first embodiment of the present invention is a wireless IC tag used for a concrete structural object quality management system which is a memory unit also called an RFID tag enabled to write and read data wherein as shown in FIG. 1, an FeRAM chip 3 called a ferroelectric memory utilizing a ferroelectric as a memory device for the IC tag is mounted on a substrate 2 including a metallic plate, a ceramic plate, or the like, and at the same time various types of sensors are connected with the FeRAM chip 3. The wireless IC tag 1 is configured, as shown in FIG. 7, to be embedded into or attached to a concrete structural object 11 to measure and save various data of the concrete structural object 11 and at the same time, as shown in FIG. 6, to write and read data between a reader/writer 9 as a writing/reading apparatus by wireless communication.

Type of the FeRAM which configures the wireless IC tag 1 may be any type such as a capacitor type or a transistor type. Here, one which is easy for use in a management system of a product or the like is a passive type FeRAM which does not include a power source but rectifies a radio wave for data access from outside to use the wave as a power source. The FeRAM chip 3 has an FeRAM which is a non-volatile memory utilizing a ferroelectric, a power source unit which generates an electric current by receiving and resonating with a radio wave from outside instead of incorporating a battery for driving, a film antenna unit for carrying out wireless communication, and a control unit for controlling the FeRAM chip 3 and a sensor which will be described later.

When compared with an EEPROM which has been used for a conventional wireless IC tag, the FeRAM configuring the FeRAM chip 3 has a function superior to the EEPROM in that times of rewriting of the EEPROM is approximately fifth power of 10 while the FeRAM can rewrite 13 power of 10 times or more. Moreover, writing voltage of the conventional EEPROM is 12V while the FeRAM is between DC 1.1 and 3V, which is quite low voltage. Therefore, a battery does not need to be incorporated in the wireless IC tag and a passive type having a power source unit for generating power by resonating with a radio wave from outside is sufficient for use and compared with the EEPROM which has been used for a conventional IC tag, writing speed of the FeRAM is 5000 times faster. Further, data retention period is 10 years or more, which is relatively longer. Further, there is another advantage in an access for rewriting. While writing was carried out by the unit of a block for the conventional EEPROM or a flash memory, FeRAM can carry out writing randomly by the unit of a word.

The control unit can be also set to prevent overwriting while information can be added to prevent information which was written in before from being falsified and it is preferable that writing/reading of data is carried out by use of a protocol. Therefore, it becomes possible to carry out writing/reading of each data by way of wireless communication with a reader/writer 9 as a writing/reading apparatus, as shown in FIG. 4, within approximately 8 KB of memory capacity. A bandwidth of a radio wave in which the FeRAM chip 3 can carry out wireless communication can be set freely and any band from LF band to UHF band suitable for wireless communication can be used. However, it is suitable to set the band width of the antenna unit to communication in the LF band which enables stable communication by ground wave, has weak directionality, is relatively less subject to effect by water, dust, and a metal, and can carry out highly reliable data communication. Here, bandwidth of the antenna unit may be set to be one for frequency band communication such as VHF band, HF band, or MF band.

Here, a management flag which can be read by the reader/writer 9 is saved in advance or when writing in the FeRAM chip 3 of the wireless IC tag 1 and the management flag is read by the reader/writer 9 when information is read or written so that it can be identified that the wireless IC tag 1 is one configuring a predetermined management system. Here, depending on the necessity, anti-collision function can be mounted on the wireless IC tag 1 so that communication is not disabled due to interference in a case where a plurality of wireless IC tags 1 are positioned in the vicinity of each tag.

A temperature sensor 4 which is connected by a wire 21 with the FeRAM chip 3 is provided to the wireless IC tag 1 and a detection unit of the temperature sensor is brought into contact with the concrete structural object 11 so that temperature of the concrete structural object 11 can be measured.

It is preferable that the temperature sensor 4 is any one of, for example, a resistance temperature detector, a thermocouple, and a thermistor and is small enough to be mounted on the substrate 2.

The resistance temperature detector is a temperature sensor utilizing a fact that electrical resistivity of a metal differs depending on the temperature. The thermocouple is a temperature sensor utilizing Seebeck effect of flowing an electric current in a certain direction and generating thermoelectric power when two types of metal such as platinum, rhenium, tungsten, silver, gold, or the like having different thermopower are joined and the joined portion is caused to have different temperatures. Although the thermocouple is generally used in the vicinity of room temperature, the thermocouple may be used in a high temperature area or a low temperature area and is superior as a sensor embedded in concrete because the thermocouple has heat resistance, acid resistance, alkaline resistance, and the like and can be mounted on the substrate 2 if a thermocouple sheet is used. The thermistor is a temperature sensor utilizing a change of resistance using a resistor that significantly changes electrical resistance by change in temperature. The thermistor can be used in temperatures from −50° C. to 350° C. and is superior as a sensor embedded in concrete.

An example of the temperature sensor 4 including a thermistor is shown in FIG. 2. A surface mounting type chip-shaped thermistor 41 is provided to be in contact with an internal electrode 42 on the substrate 2 and periphery thereof is covered with plate layers 43 and 44 while an upper surface thereof is covered with a protection film 45. Temperature is measured by use of a principle that resistance of the thermistor 41 is increased along with increase in temperature or resistance is decreased along with increase in temperature.

The temperature sensor 4 measures temperature of concrete of the concrete structural object 11 with a certain interval by output of a measurement signal from the control unit of the FeRAM chip 3, when the reader/writer 9 reads data, or all the time and saves temperature data thus output as an electric signal in the memory of the FeRAM chip 3.

Here, although the temperature sensor 4 is mounted on the substrate 2 in FIG. 1, the temperature sensor 4 does not need to be mounted on the substrate 2 and it is sufficient if the sensor is wired with the FeRAM chip 3 to be enabled to communicate with the chip. Moreover, as a power source of the temperature sensor 4, an external power source 12 may be used as shown in FIG. 7. In addition, type of the temperature sensor is not limited to the above-mentioned ones.

Moreover, a Ph sensor 5 connected by a wire 22 with the FeRAM chip 3 is provided to the wireless IC tag 1 and a detection unit of the Ph sensor is brought into contact with the concrete structural object 11 so that hydrogen-ion exponent of the concrete structural object 11 can be measured.

The Ph sensor 5 is an imaging sensor which uses a semi-conductor including, for example, an image sensor on which a thin gel film is formed. The gel film is brought into contact with a surface of a portion of the concrete structural object to be measured to detect reactivity on the surface, amount of alkaline attached to the film, amount of acid/alkaline released from inside of the measured portion. Otherwise, the Ph sensor 5 is a glass electrode sensor having a glass electrode and a comparison electrode for detecting potential difference between the electrodes. It is preferable that the Ph sensor 5 is small enough to be mounted on the substrate 2 and can repeatedly measure the hydrogen-ion exponent.

An example of the Ph sensor 5 using a sheet-type composite glass electrode is shown in FIG. 3. The detection unit of the surface mounting type sheet-type composite glass electrode sensor has a Ph responsive glass electrode 51, a comparison electrode 52, and a liquid junction 53 and hydrogen-ion exponent is measured by detecting potential difference between the glass electrode and the comparison electrode. Here, if the sensor is used after the concrete structural object is hardened, an imaging sensor using a semi-conductor is more suitable.

The Ph sensor 5 measures the hydrogen-ion exponent of concrete of the concrete structural object 11 with a certain interval by output of a measurement signal from the control unit of the FeRAM chip 3, when the reader/writer 9 reads data, or all the time, and saves the hydrogen-ion exponent data output as an electric signal in the memory of the FeRAM chip 3.

Here, although the Ph sensor 5 is mounted on the substrate 2 in FIG. 1, the Ph sensor 5 does not need to be mounted on the substrate 2 and it is sufficient if the sensor is wired with the FeRAM chip 3 to be enabled to communicate with the chip. Moreover, as a power source of the Ph sensor 5, the external power source 12 may be used as shown in FIG. 7. In addition, type of the Ph sensor is not limited to the above-mentioned ones.

A distortion sensor 6 connected by a wire 23 with the FeRAM chip 3 is provided to the wireless IC tag 1 and a detection unit of the distortion sensor can measure the distortion of the concrete structural object 11.

The distortion sensor is a displacement sensor for detecting the amount of change in relative positions of at least two points of the concrete structural object and it is preferable if the sensor is small enough to be mounted on the substrate 2.

It is preferable that the displacement sensor is a strain gauge using a bridge circuit which is provided while connecting at least two points in X and Y directions of the concrete structural object, a distortion sensor using an electromagnetic method, a volume strain meter, or the like so that amount of change such as distortion or displacement in at least two points of the concrete structural object can be detected. Moreover, displacement of positions of several distortion sensors of wireless IC tags may be comprehensively detected to measure distortion of the whole of the concrete structural object.

The distortion sensor measures the amount of change in distortion of the concrete structural object 11 with a certain interval by output of a measurement signal from the control unit of the FeRAM chip 3, when the reader/writer 9 reads data, or all the time, and saves the distortion data output as an electric signal in the memory of the FeRAM chip 3.

Here, although the distortion sensor 6 is mounted on the substrate 2 in FIG. 1, the distortion sensor 6 does not need to be mounted on the substrate 2 and it is sufficient if the sensor is wired with the FeRAM chip 3 to be enabled to communicate with the chip. Moreover, as a power source of the distortion sensor 6, the external power source 12 may be used as shown in FIG. 7. In addition, type of the distortion sensor is not limited to the above-mentioned ones.

Further, in the present embodiment, the temperature sensor 4, the Ph sensor 5, and the distortion sensor 6 are connected with the FeRAM chip 3, mounted on the one substrate 2, and temperature, hydrogen-ion exponent, and distortion of the concrete structural object 11 are measured by the one wireless IC tag 1 and the data can be saved. However, the sensor provided to the wireless IC tag may be any one of the sensors or two of the sensors.

A wireless IC tag 7 of the present invention showing a second embodiment of the present invention is the hybrid-type wireless IC tag 7 which is a memory unit also called an RFID tag enabled to write and read data wherein as shown in FIG. 4, the FeRAM chip 3 called a ferroelectric memory utilizing a ferroelectric as a memory device for the IC tag is mounted on the substrate 2 including a metallic plate, a ceramic plate, or the like, and at the same time a UHF band communication antenna chip 8 for carrying out communication in a UHF band having a wide communication area to be enabled to read and write in several meters of communication distance by the reader/writer 9 for management of a moving body or for carrying out management in a wide area is mounted.

Then, the hybrid-type wireless IC tag 7 is a wireless IC tag used for a concrete structural object management system including various types of sensors electrically connected with the FeRAM chip 3. The wireless IC tag 7 is embedded in a concrete structural object, measures various data of the concrete structural object, saves the measured data, and writes in and read out data between the reader/writer 9 by wireless communication.

In the wireless IC tag 7, control of the FeRAM chip 3 and the UHF band communication antenna chip 8 are carried out by a control unit mounted on the FeRAM chip 3. According to the communication frequency band of the reader/writer, the antenna unit of the FeRAM chip 3 or the UHF band communication antenna chip 8 carries out communication and at the same time transmitted data is controlled by the control unit and saved in the large-volume memory of the FeRAM chip 3.

For example, if an LF band frequency radio wave is output from the reader/writer, the antenna unit of the FeRAM chip 3 receives the radio wave and the control unit carries out control so that the data thus transmitted is saved in the memory unit of the FeRAM chip 3. On the other hand, if a UHF band frequency radio wave is output from the reader/writer 9, the UHF band communication antenna chip 8 receives the radio wave and when the UHF band communication antenna chip 8 receives the wave, it is controlled that the data thus transmitted is saved in the memory unit of the FeRAM chip 3 and the data is saved in the memory unit of the FeRAM chip 3 via the UHF band communication antenna chip 4.

Here, a management flag which can be read by the reader/writer 9 is saved in advance or when writing in the FeRAM chip 3 of the wireless IC tag 7 and the management flag is read by the reader/writer 9 when information is read or written so that it can be identified that the wireless IC tag 7 is one configuring a predetermined management system. Here, depending on the necessity, anti-collision function can be mounted on the wireless IC tag 7 so that communication is not disabled due to interference in a case where a plurality of wireless IC tags 7 are positioned in the vicinity of each tag.

The temperature sensor 4, the Ph sensor 5, and the distortion sensor 6 are connected with the FeRAM chip 3 respectively by the wire 24, the wire 25, and the wire 26. Configuration of each sensor is the similar to that of the first embodiment and therefore explanation thereof is omitted here.

Here, in FIG. 4, each sensor is mounted on the substrate 2. However, the sensor does not need to be mounted on the substrate 2 and may be provided in a condition where the sensor is electrically connected with the FeRAM chip 3. Moreover, as shown in FIG. 7, the external power source 12 may be used as a power source of each sensor. In addition, type of the sensors is not limited to the above-mentioned ones.

Further, in the present embodiment, the temperature sensor 4, the Ph sensor 5, and the distortion sensor 6 are connected with one FeRAM chip 3 and temperature, hydrogen-ion exponent, and distortion of the concrete structural object 11 can be measured by one wireless IC tag 7 and saved. However, the sensor provided to the wireless IC tag 7 may be any one of the sensors or two of the sensors.

Further, as shown in FIG. 5, it is preferable that the embedded wireless IC tag is covered with an insulating material to protect the chip while retaining a condition where each sensor can detect temperature, hydrogen-ion exponent, and distortion.

Next, as a third embodiment of the present invention, a wireless IC tag 13 to which a battery recharged by a recharging device in a contactless manner is connected will be explained. As shown in FIG. 8, the wireless IC tag 13 is a wireless IC tag 1 of the first embodiment to which a battery 14 enabled to be recharged by wireless communication is provided and the wireless IC tag 13 includes a recharging mechanism. Then, for example, the battery is recharged by communication from the reader/writer 9 which mounts the recharging device or functions as a recharging device, as shown in FIG. 9. Other configuration of the wireless IC tag 13 is similar to that of the wireless IC tag 1 of the first embodiment.

On the wireless IC tag 13, the FeRAM chip 3 utilizing a ferroelectric as a memory device for the IC tag, the temperature sensor 4, the Ph sensor 5, and the distortion sensor 6 are mounted. The battery 14 which is a secondary battery having a wireless communication mechanism for receiving a radio wave in a specific frequency bandwidth is provided on the substrate 2 and is electrically connected with the temperature sensor 4, the Ph sensor 5, and the distortion sensor 6. Communication is carried out between the wireless communication mechanism provided to the recharging device and the wireless communication mechanism provided to the wireless IC tag 13 side by use of near field communication technology to recharge the battery 14 on the wireless IC tag side. The electric power thus accumulated is used as a power source for driving the wireless IC tag 13 or the temperature sensor 4, the Ph sensor 5, and the distortion sensor 6.

For example, the battery 14 of the wireless IC tag 13 embedded in a concrete structural object or the like is recharged when the reader/writer 9 including a recharging device carries out wireless communication and power is supplied from the battery 14 to each of the sensors to drive the sensors and to measure various types of data of the concrete structural object, as shown in FIG. 9.

Here, a method of recharging may be one using electromagnetic induction, other than the above-mentioned near field communication technology. That is, a coil is provided respectively to the recharging device and the battery and if an electric current is caused to flow to the coil on the recharging device side, an electric current flows to the coil on the battery side and this electric current is accumulated. Moreover, the recharging device may not be mounted on the reader/writer 9 and may be separately provided. In addition, the battery 14 may not be provided on the substrate 2 and may be electrically connected with the wireless IC tag.

Here, although the wireless IC tag 13 includes the temperature sensor 4, the Ph sensor 5, and the distortion sensor 6, the number of sensors that the wireless IC tag includes may be one or two and a sensor which is electrically connected with the FeRAM chip 3 may be connected with the battery 14.

Moreover, a fourth embodiment of the present invention is a wireless IC tag including a recharging mechanism and the wireless IC tag 7 showing the second embodiment of the present invention, to which the above-mentioned battery 14 which can be recharged by wireless communication is provided. The wireless IC tag 15 includes the hybrid-type wireless IC tag 7 having the FeRAM chip 3, the UHF band communication antenna chip 8, the temperature sensor 4, the Ph sensor 5, and the distortion sensor 6, to which the battery 14 is provided. The battery 14 and the temperature sensor 4, the Ph sensor 5, and the distortion sensor 6 are electrically connected.

Next, a wireless IC tag 16 to which a power generation mechanism is electrically connected will be explained as a fifth embodiment of the present invention. As shown in FIG. 11, the wireless IC tag 16 includes the wireless IC tag 1 of the first embodiment to which a power generation mechanism 17 for generating power by itself is provided and therefore is a wireless IC tag including the power generation mechanism 17. Other configuration of the wireless IC tag 16 is similar to that of the wireless IC tag 1 of the first embodiment.

The FeRAM chip 3 mounting an FeRAM which utilizes a ferroelectric as a memory device for an IC tag is mounted on the wireless IC tag. The power generation mechanism 17 is electrically connected with the temperature sensor 4, the Ph sensor 5, and the distortion sensor 6 and is provided on the substrate. The power generation mechanism 17 is a vibration power generation device which generates power by vibration and generates relatively weak power by motion of a human, vibration caused by driving of the device, vibration of a building or a bridge caused by passage of a vehicle or the like. Then, the power generated by the power generation mechanism may be directly used or may be accumulated in a secondary battery provided to the power generation mechanism. Power generated by the power generation mechanism 17 is used as a power source for driving the wireless IC tag 16, the temperature sensor 4, the Ph sensor 5, and the distortion sensor 6.

For example, in a case where a human carrying the wireless IC tag 16 moves or the wireless IC tag 16 embedded in or attached to a concrete structural object, a bridge, a product, or the like is vibrated by passage of a vehicle or the like or by swing while being carried, the power generation mechanism 17 generates power utilizing the vibration as energy.

Here, the power generation mechanism 17 is not limited to the above-mentioned vibration power generation device and may be a mechanism which generates power by heat from outside as a thermoelectric device or a power generation mechanism by wireless communication for generating power by radio wave from outside such as RF wave, and may be a system which uses various types of external energy, which is generally called harvester technology. Here, the power generation mechanism 17 may not be provided on the substrate 2 and may be provided in the vicinity of the wireless IC tag to be electrically connected with each sensor.

Further, a sixth embodiment of the present invention is a wireless IC tag including a power generation mechanism. The sixth embodiment comprises the wireless IC tag 7 showing the second embodiment of the present invention to which the above-mentioned power generation mechanism 17 is provided. The wireless IC tag 18 is a wireless IC tag including the hybrid-type wireless IC tag 7 which comprises the FeRAM chip 3, the UHF band communication antenna chip 8, the temperature sensor 4, the Ph sensor 5, and the distortion sensor 6 to which the power generation mechanism 17 is provided. The power generation mechanism 17 and the temperature sensor 4, the Ph sensor 5, and the distortion sensor 6 are electrically connected.

A quality management system of the concrete structural object 11 using the wireless IC tag 1 will be explained. As shown in FIG. 7, the wireless IC tag 1 is embedded for use in concrete when the concrete structural object 11 is built by casting concrete including cement, aggregate, and water or mortar into a formwork. Moreover, depending on the necessity, the wireless IC tag 1 may be attached to a wall surface of the concrete structural object 11 after casting to be used. At this time, driving power of each sensor may be supplied from the external power source 12.

Then, temperature, hydrogen-ion exponent, and distortion of the concrete structural object 11 before the concrete structural object 11 is hardened and temperature, hydrogen-ion exponent, and distortion of the concrete structural object 11 after the concrete structural object 11 is hardened are measured periodically by the control of the control unit of the FeRAM chip 3 in advance or when communication between the reader/writer 9 is carried out.

When time for measurement comes, the control unit 3 of the FeRAM chip 3 controls the temperature sensor 4, the Ph sensor 5, and the distortion sensor 6 connected with the FeRAM chip 3 and depending on the control, each of the sensors measures concrete temperature of the concrete structural object 11, hydrogen-ion exponent of the concrete structural object 11, and distortion of the concrete structural object 11. Then, the control unit saves the data thus measured in the memory of the FeRAM chip 3.

Moreover, contrary to the above, in a case where the temperature sensor 4, the Ph sensor 5, and the distortion sensor 6 which are set to measure all the time detect a change, the control unit 3 of the FeRAM chip 3 may be operated to save the data of concrete temperature of the concrete structural object 11, hydrogen-ion exponent of the concrete structural object 11, and distortion of the concrete structural object 11 detected by each of the sensors in the memory of the FeRAM chip 3.

As shown in FIG. 6, the reader/writer 9 is an apparatus which can carry out data communication between the wireless IC tag 1 and reads out and writes in various data or the like by wireless communication between the wireless IC tag. A manager of the concrete structural object 11 such as a person concerned in the construction or a manager of the building directs the reader/writer 9 to a spot where the wireless IC tag 1 is embedded or attached to carry out communication so that the above-mentioned various types of data saved in the wireless IC tag is read out. The data thus read out by the reader/writer 9 may be stored in a computer 10 for management.

Moreover, if written data is output from the reader/writer 9, the antenna unit of the FeRAM chip 3 of the wireless IC tag 1 receives the data and the data is saved in the memory of the FeRAM chip 3.

Further, in a manufacturing process of a cement product in which cement, aggregate such as gravel, water, and the like are mixed, manufacturing information including product characteristic values such as water/cement ratio of the cement product, cement admixture, or temperature measured by an automatic measurement device of the cement product, production date, and the like may be written in the wireless IC tag 1 before the wireless IC tag 1 is embedded in the concrete structural object 11.

Configuration of such a concrete quality management system enables a construction company on the construction site, a client of the construction, a user, and various organizations concerned to know the temperature, hydrogen-ion exponent, and distortion of the concrete structural object at any time from the casting of concrete to completion of the concrete structural object and thereafter only by carrying out communication with the wireless IC tag 1 by use of the reader/writer 9. Thus, it becomes possible to estimate deterioration of the concrete structural object and danger of collapse due to external factors such as earthquake, and to improve safety of the structural object. Here, in the present embodiment, a system including all of the temperature sensor 4, the Ph sensor 5, and the distortion sensor 6 has been explained. However, the system may have any one of the sensors or two of the sensors which are connected with the FeRAM chip 3 to control the one or two sensors.

Moreover, the wireless IC tag used for the above-mentioned system may be any one of the wireless IC tags of second to fifth embodiments of the present invention wherein the wireless IC tag itself has a recharging mechanism or a power generation mechanism, other than the wireless IC tag of the first embodiment of the present invention. In this case, the external power source 12 does not need to be provided and a power source for driving each sensor can be provided to the wireless IC tag.

### INDUSTRIAL APPLICABILITY

Since a wireless IC tag having a temperature sensor which can carry out wireless data communication is used, measurement of temperature inside the concrete and extraction of temperature data can be carried out easily. At the same time, since the temperature data measured with a certain interval can be saved in a large-volume memory of the wireless IC tag, it becomes possible for a person in charge of the construction site or a person who manages after casting to easily and quickly carry out estimation of strength of the concrete by use of temperature or accumulated temperature by each of actually used concrete and therefore the present invention contributes to improvement of safety of a concrete structural object.

Moreover, since a wireless IC tag having a Ph sensor which can carry out wireless data communication is used, measurement of hydrogen-ion exponent inside the concrete and extraction of hydrogen-ion exponent data can be carried out easily. At the same time, since the hydrogen-ion exponent data measured with a certain interval can be saved in a large-volume memory of the wireless IC tag, it becomes possible for a person in charge of the construction site or a person who manages after casting to easily and quickly carry out estimation of neutralization of the concrete by each of actually used concrete by use of the hydrogen-ion exponent data and therefore the present invention contributes to improvement of safety of a concrete structural object.

Further, since a wireless IC tag having a distortion sensor which can carry out wireless data communication is used, measurement of distortion of the concrete structural object and extraction of distortion data can be carried out easily. At the same time, since the distortion data measured with a certain interval can be saved in a large-volume memory of the wireless IC tag, it becomes possible for a person in charge of the construction site or a person who manages after casting to easily and quickly measure distortion of concrete by each actually used concrete and therefore it becomes possible to find out deterioration of the concrete structural object, crack or the like of the concrete structural object due to an external factor such as earthquake by use of the distortion data. Therefore the present invention contributes to improvement of safety of a concrete structural object.

1. A wireless IC tag attached to or embedded in a concrete structural object which can carry out writing and reading of data between a writing/reading apparatus by wireless communication, comprising:
a ferroelectric memory using a ferroelectric having a power source unit for receiving a radio wave from outside and for generating an electric current by resonating with the radio wave and an antenna unit for carrying out wireless communication in a predetermined frequency bandwidth; and
a temperature sensor electrically connected with the ferroelectric memory,
wherein temperature data of the structural object measured by the temperature sensor is saved in the ferroelectric memory.

2. A wireless IC tag attached to or embedded in a concrete structural object which can carry out writing and reading of data between a writing/reading apparatus by wireless communication, comprising:
a ferroelectric memory using a ferroelectric having a power source unit for receiving a radio wave from outside and for generating an electric current by resonating with the radio wave and an antenna unit for carrying out wireless communication in a predetermined frequency bandwidth; and
a Ph sensor electrically connected with the ferroelectric memory,
wherein hydrogen-ion exponent data of the structural object measured by the Ph sensor is saved in the ferroelectric memory.

3. A wireless IC tag attached to or embedded in a concrete structural object which can carry out writing and reading of data between a writing/reading apparatus by wireless communication, comprising:
a ferroelectric memory using a ferroelectric having a power source unit for receiving a radio wave from outside and for generating an electric current by resonating with the radio wave and an antenna unit for carrying out wireless communication in a predetermined frequency bandwidth; and
a distortion sensor electrically connected with the ferroelectric memory,
wherein distortion data of the structural object measured by the distortion sensor is saved in the ferroelectric memory.

4. A wireless IC tag attached to or embedded in a concrete structural object which can carry out writing and reading of data between a writing/reading apparatus by wireless communication, comprising:
a ferroelectric memory using a ferroelectric having a power source unit for receiving a radio wave from outside and for generating an electric current by resonating with the radio wave and an antenna unit for carrying out wireless communication in a predetermined frequency bandwidth; and
at least two of temperature sensor, a Ph sensor, and a distortion sensor electrically connected with the ferroelectric memory,
wherein at least any one of temperature data of the structural object measured by the temperature sensor, hydrogen-ion exponent data of the structural object measured by the Ph sensor, and distortion data of the structural object measured by the distortion sensor is saved in the ferroelectric memory.

5. The wireless IC tag according to claim 1, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth are connected to be mounted on the substrate so that communication in a frequency band longer than the UHF band is carried out by the antenna unit of the ferroelectric memory and the data is saved in the ferroelectric memory, and at the same time communication in the UHF band is carried out by the UHF band communication antenna chip and the data is saved in the ferroelectric memory.

6. The wireless IC tag according to claim 1, wherein the wireless IC tag includes the substrate covered with an insulating material which mounts a ferroelectric memory using a ferroelectric having a power source unit for receiving a radio wave from outside and for generating an electric current by resonating with the radio wave and an antenna unit for carrying out wireless communication in a predetermined frequency bandwidth.

7. The wireless IC tag according to claim 1, wherein the temperature sensor is any one of a resistance temperature detector, a thermocouple, and a thermistor and an electric signal detected by the temperature sensor is saved in the ferroelectric memory.

8. The wireless IC tag according to claim 2, wherein the Ph sensor is a semi-conductor imaging sensor for detecting reactivity at a measurement portion, amount of acid/alkaline attached to the portion, amount of acid/alkaline released from inside of the measurement portion, or the like, by causing a film provided to the Ph sensor to be brought into contact with the measurement portion of the concrete structural object or a glass electrode sensor having a glass electrode and a comparison electrode for detecting potential difference between the electrodes and an electric signal detected by the Ph sensor is saved in the ferroelectric memory.

9. The wireless IC tag according to claim 3, wherein the distortion sensor is a displacement sensor for detecting the amount of change in relative positions of at least two points of the concrete structural object and an electric signal detected by the distortion sensor is saved in the ferroelectric memory.

10. The wireless IC tag according to claim 1, wherein the sensor that the wireless IC tag includes is mounted on the substrate.

11. The wireless IC tag according to claim 1, wherein the wireless IC tag is electrically connected with a battery which is recharged by a recharging device in a contactless manner.

12. The wireless IC tag according to claim 11, wherein the battery is recharged in a contactless manner by a radio wave from the recharging device which is in a predetermined frequency band.

13. The wireless IC tag according to claim 11, wherein the battery is mounted on the substrate.

14. The wireless IC tag according to claim 11, wherein the recharging device for recharging the battery is provided to the writing/reading apparatus.

15. The wireless IC tag according to claim 11, wherein power to drive the sensor that the wireless IC tag includes is supplied from the battery which is recharged from the recharging device in a contactless manner.

16. The wireless IC tag according to claim 1, wherein the wireless IC tag is electrically connected with a power generation mechanism which generates power by itself by vibration, heat, or radio wave.

17. The wireless IC tag according to claim 16, wherein the power generation mechanism is mounted on the substrate.

18. The wireless IC tag according to claim 16, wherein power for driving the sensor that the wireless IC tag includes is supplied from the power generation mechanism which generates power by itself by vibration, heat, or radio wave.

19. A concrete structural object quality management system using a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and a temperature sensor electrically connected with the ferroelectric memory, wherein a control unit mounted on the ferroelectric memory has a means for controlling the temperature sensor, a means for the temperature sensor to measure temperature of the concrete structural object, and a means for saving temperature data of the structural object thus measured in the ferroelectric memory.

20. A concrete structural object quality management system using a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and a Ph sensor electrically connected with the ferroelectric memory, wherein a control unit mounted on the ferroelectric memory has a means for controlling the Ph sensor, a means for the Ph sensor to measure hydrogen-ion exponent of the concrete structural object, and a means for saving hydrogen-ion exponent data of the structural object thus measured in the ferroelectric memory.

21. A concrete structural object quality management system using a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and a distortion sensor electrically connected with the ferroelectric memory, wherein a control unit mounted on the ferroelectric memory has a means for controlling the distortion sensor, a means for the distortion sensor to measure distortion of the concrete structural object, and a means for saving distortion data of the structural object thus measured in the ferroelectric memory.

22. The concrete structural object quality management system according to claim 19, wherein the system comprises a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and at least two of a temperature sensor, a Ph sensor, and a distortion sensor which are electrically connected with the ferroelectric memory, wherein a control unit mounted on the ferroelectric memory has a means for controlling each of the sensors, a means for the sensors to measure data of the concrete structural object, and a means for saving the data of the concrete structural object thus measured in the ferroelectric memory.

23. A concrete structural object quality management system using a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and at least any one of a temperature sensor, a Ph sensor, and a distortion sensor electrically connected with the ferroelectric memory and including a means for saving data detected by any one of the sensors if an amount of change is detected by the sensor in the ferroelectric memory.

24. The concrete structural object quality management system according to claim 19, wherein the wireless IC tag is electrically connected with a battery which is recharged by a recharging device in a contactless manner and power to drive the sensor that the wireless IC tag includes is supplied from the battery.

25. The concrete structural object quality management system according to claim 19, wherein the wireless IC tag is electrically connected with a power generation mechanism which generates power by itself by vibration, heat, or radio wave and power for driving the sensor that the wireless IC tag includes is supplied from the power generation mechanism.

26. The wireless IC tag according to claim 2, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth are connected to be mounted on the substrate so that communication in a frequency band longer than the UHF band is carried out by the antenna unit of the ferroelectric memory and the data is saved in the ferroelectric memory, and at the same time communication in the UHF band is carried out by the UHF band communication antenna chip and the data is saved in the ferroelectric memory.

27. The wireless IC tag according to claim 3, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth are connected to be mounted on the substrate so that communication in a frequency band longer than the UHF band is carried out by the antenna unit of the ferroelectric memory and the data is saved in the ferroelectric memory, and at the same time communication in the UHF band is carried out by the UHF band communication antenna chip and the data is saved in the ferroelectric memory.

28. The wireless IC tag according to claim 4, wherein a ferroelectric memory using a ferroelectric having a power source unit for receiving a radio wave from outside and for generating an electric current by resonating with the radio wave and an antenna unit for carrying out wireless communication in a predetermined frequency bandwidth, and a UHF band communication antenna chip for receiving a radio wave of a UHF bandwidth are connected to be mounted on the substrate so that communication in a frequency band longer than the UHF band is carried out by the antenna unit of the ferroelectric memory and the data is saved in the ferroelectric memory, and at the same time communication in the UHF band is carried out by the UHF band communication antenna chip and the data is saved in the ferroelectric memory.

29. The wireless IC tag according to claim 2, wherein the wireless IC tag includes the substrate covered with an insulating material which mounts a ferroelectric memory using a ferroelectric having a power source unit for receiving a radio wave from outside and for generating an electric current by resonating with the radio wave and an antenna unit for carrying out wireless communication in a predetermined frequency bandwidth.

30. The wireless IC tag according to claim 3, wherein the wireless IC tag includes the substrate covered with an insulating material which mounts a ferroelectric memory using a ferroelectric having a power source unit for receiving a radio wave from outside and for generating an electric current by resonating with the radio wave and an antenna unit for carrying out wireless communication in a predetermined frequency bandwidth.

31. The wireless IC tag according to claim 4, wherein the wireless IC tag includes the substrate covered with an insulating material which mounts a ferroelectric memory using a ferroelectric having a power source unit for receiving a radio wave from outside and for generating an electric current by resonating with the radio wave and an antenna unit for carrying out wireless communication in a predetermined frequency bandwidth.

32. The wireless IC tag according to claim 4, wherein the temperature sensor is any one of a resistance temperature detector, a thermocouple, and a thermistor and an electric signal detected by the temperature sensor is saved in the ferroelectric memory.

33. The wireless IC tag according to claim 4, wherein the Ph sensor is a semi-conductor imaging sensor for detecting reactivity at a measurement portion, amount of acid/alkaline attached to the portion, amount of acid/alkaline released from inside of the measurement portion, or the like, by causing a film provided to the Ph sensor to be brought into contact with the measurement portion of the concrete structural object or a glass electrode sensor having a glass electrode and a comparison electrode for detecting potential difference between the electrodes and an electric signal detected by the Ph sensor is saved in the ferroelectric memory.

34. The wireless IC tag according to claim 4, wherein the distortion sensor is a displacement sensor for detecting the amount of change in relative positions of at least two points of the concrete structural object and an electric signal detected by the distortion sensor is saved in the ferroelectric memory.

35. The wireless IC tag according to claim 2, wherein the sensor that the wireless IC tag includes is mounted on the substrate.

36. The wireless IC tag according to claim 3, wherein the sensor that the wireless IC tag includes is mounted on the substrate.

37. The wireless IC tag according to claim 4, wherein the sensor that the wireless IC tag includes is mounted on the substrate.

38. The wireless IC tag according to claim 2, wherein the wireless IC tag is electrically connected with a battery which is recharged by a recharging device in a contactless manner.

39. The wireless IC tag according to claim 3, wherein the wireless IC tag is electrically connected with a battery which is recharged by a recharging device in a contactless manner.

40. The wireless IC tag according to claim 4, wherein the wireless IC tag is electrically connected with a battery which is recharged by a recharging device in a contactless manner.

41. The wireless IC tag according to claim 2, wherein the wireless IC tag is electrically connected with a power generation mechanism which generates power by itself by vibration, heat, or radio wave.

42. The wireless IC tag according to claim 3, wherein the wireless IC tag is electrically connected with a power generation mechanism which generates power by itself by vibration, heat, or radio wave.

43. The wireless IC tag according to claim 4, wherein the wireless IC tag is electrically connected with a power generation mechanism which generates power by itself by vibration, heat, or radio wave.

44. The concrete structural object quality management system according to claim 20, wherein the system comprises a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and at least two of a temperature sensor, a Ph sensor, and a distortion sensor which are electrically connected with the ferroelectric memory, wherein a control unit mounted on the ferroelectric memory has a means for controlling each of the sensors, a means for the sensors to measure data of the concrete structural object, and a means for saving the data of the concrete structural object thus measured in the ferroelectric memory.

45. The concrete structural object quality management system according to claim 21, wherein the system comprises a wireless IC tag attached to or embedded in a concrete structural object which can carry out writing and reading of data between a writing/reading apparatus by wireless communication, including a ferroelectric memory using a ferroelectric having a power source unit for receiving a radio wave from outside and for generating an electric current by resonating with the radio wave and an antenna unit for carrying out wireless communication in a predetermined frequency bandwidth, and at least two of a temperature sensor, a Ph sensor, and a distortion sensor which are electrically connected with the ferroelectric memory, wherein a control unit mounted on the ferroelectric memory has a means for controlling each of the sensors, a means for the sensors to measure data of the concrete structural object, and a means for saving the data of the concrete structural object thus measured in the ferroelectric memory.

46. The concrete structural object quality management system according to claim 20, wherein the wireless IC tag is electrically connected with a battery which is recharged by a recharging device in a contactless manner and power to drive the sensor that the wireless IC tag includes is supplied from the battery.

47. The concrete structural object quality management system according to claim 21, wherein the wireless IC tag is electrically connected with a battery which is recharged by a recharging device in a contactless manner and power to drive the sensor that the wireless IC tag includes is supplied from the battery.

48. The concrete structural object quality management system according to claim 23, wherein the wireless IC tag is electrically connected with a battery which is recharged by a recharging device in a contactless manner and power to drive the sensor that the wireless IC tag includes is supplied from the battery.

49. The concrete structural object quality management system according to claim 20, wherein the wireless IC tag is electrically connected with a power generation mechanism which generates power by itself by vibration, heat, or radio wave and power for driving the sensor that the wireless IC tag includes is supplied from the power generation mechanism.

50. The concrete structural object quality management system according to claim 21, wherein the wireless IC tag is electrically connected with a power generation mechanism which generates power by itself by vibration, heat, or radio wave and power for driving the sensor that the wireless IC tag includes is supplied from the power generation mechanism.

51. The concrete structural object quality management system according to claim 23, wherein the wireless IC tag is electrically connected with a power generation mechanism which generates power by itself by vibration, heat, or radio wave and power for driving the sensor that the wireless IC tag includes is supplied from the power generation mechanism.
